(19) United States
(12) Patent Application Publication
(10) Pub. No.: US 2009/0261943 A1
(43) Pub. Date: Oct. 22, 2009

(54) METHOD AND APPARATUS FOR PROVIDING PREMISE MONITORING

(76) Inventors: RITTWIK JANA, Parsippany, NJ (US); Vaidyanathan Ramaswami, Neshanic Station, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/103,932

(22) Filed: Apr. 16, 2008

(51) Int. Cl. G05B 23/02

(52) U.S. Cl. 340/3.1

(57) ABSTRACT

A method and apparatus for enabling the use of an IP based network that supports triple play services, comprising voice service, data service and video service, to provide premise monitoring are disclosed. For example, the method monitors a premise via at least one sensing device, and sends security related information to a headend office in a communication network when a security event is detected, wherein the communication network is a triple play service network supporting a voice service, a video service, and a data service.

The present invention relates generally to communication networks and, more particularly, to a method and apparatus for providing premise monitoring in communication networks, e.g., packet networks such as Internet Protocol (IP) networks supporting triple play network services.

### BACKGROUND OF THE INVENTION

Current premise monitoring systems send, upon a security break-in event, an alarm notification message to a monitoring service or other designated recipients using the Public Switched Telephone Network (PSTN). The alarm notification message comprises computer code messages sent to a monitoring service or prerecorded audio messages sent to the designated recipients. The occurrence of the break-in event, e.g., an unlawful entry, triggers the notification message to be sent to the monitoring service command center so that appropriate action can be taken, e.g., police dispatch. These solutions currently lack the full capabilities of video and data.

### SUMMARY OF THE INVENTION

In one embodiment, the present invention enables the use of an IP based network that supports triple play services, comprising voice service, data service and video service, to provide premise monitoring. For example, the method monitors a premise via at least one sensing device, and sends security related information to a headend office in a communication network when a security event is detected, wherein the communication network is a triple play service network supporting a voice service, a video service, and a data service.

### BRIEF DESCRIPTION OF THE DRAWINGS

The teaching of the present invention can be readily understood by considering the following detailed description in conjunction with the accompanying drawings, in which:

FIG. 1 illustrates an illustrative premise security monitoring using triple play service network related to the present invention;

FIG. 2 illustrates a flowchart of a method for providing premise security monitoring of the present invention; and

FIG. 3 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

Current premise monitoring systems send, upon a security break-in event, an alarm notification message to a monitoring service or other designated recipients using the Public Switched Telephone Network (PSTN). The alarm notification message only comprises computer code messages sent to a monitoring service or prerecorded audio messages sent to the designated recipients. However, these solutions currently lack the full capabilities of video and data.

To address this criticality, the present invention enables the use of an IP based network, e.g., a network that supports triple play services, comprising voice service (e.g., Voice over IP), data service and video service (e.g., television or movie signals), to provide premise monitoring. The present invention provides premise security monitoring capabilities that include visual, data and/or audio messages upon triggering of an alarm. The added capabilities to send security related information comprising one or more of: video images, still images, pertinent security sensor data (e.g., time stamp, location, zone triggered) and/or audio messages significantly enhance the capability for premise monitoring and also increase the value to the subscriber in subscribing to the triple play services provided by the communications service provider which can lead to greater customer loyalty.

The present invention enables a premise surveillance system that is used in conjunction with triple play services provided by a triple play service provider. Triple play services usually entail the support of Voice over Internet Protocol (VoIP) service, television programming video service, as well as data service to an end consumer.

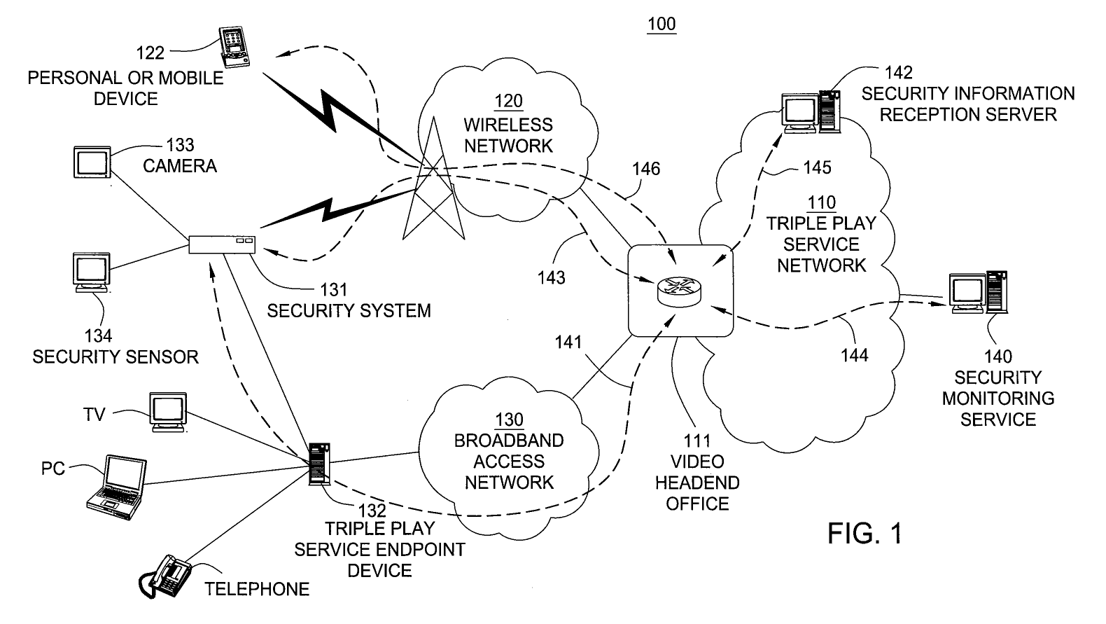

To better understand the present invention, FIG. 1 illustrates an illustrative premise security monitoring architecture 100 using a triple play service network related to the present invention. In FIG. 1 a subscriber subscribes to triple play services using triple play service network 110. The subscriber uses a triple play service endpoint device 132 to access triple play service network 110 via an access network, e.g., a broadband access network 130. In one embodiment, the subscriber subscribes to voice, video and TV, as well as data services. In addition, the subscriber uses security system 131 to support premise security monitoring. For example, camera 133 and security sensor 134 are connected to the security system 131 using wired connections or wireless connections.

In one embodiment, the present invention allows a triple play service provider to provide additional capabilities to security systems by utilizing a prioritized and reserved bandwidth in the broadband access network 130, and the triple play service network 110, e.g., a reserved access and core network bandwidth is apportioned for the security solution that carries critical security information. The security information include, but is not limited to, different video camera feeds, VoIP feeds for distress calls, still picture feed, and sensor data messages generated by the sensor network of security system 131, e.g., a heart beat check alarm (e.g., a periodic heart beat signal and/or response is missing), a fire alarm (e.g., a signal from a smoke sensor or a temperature sensor), a motion sensing alarm (e.g., a signal from a motion sensing sensor), an entry alarm (e.g., a signal from an entry way sensor or a window sensor) or a gas sensing alarm (e.g., a carbon monoxide sensor or a natural gas sensor). Greater security of the data arises from features of the implementation and network based storage and retrieval capabilities using security information reception server 142 (broadly a storage server). For example, the security information received from a subscriber premise can be securely stored in security information reception server 142, which can be used for law enforcement purposes, proof of insurance claim purposes, and so on.

In one embodiment, security system 131 uses flow 141 to send video images, still images, and security sensor surveillance information with priority access via broadband access network 130 to a video headend office 111. Similarly, security system 131 may use flow 143 to send video images, still images, and security sensor surveillance information data (broadly sensor data) via a wireless network 120 to the video headend office 111. The use of both wired and wireless networks to send security related surveillance information enhances the overall survivability and reliability of the security service.

In one embodiment, the present invention comprises surveillance zones inside a customer's premise monitored by security system 131. Each zone can be identified uniquely and may comprise surveillance video cameras, which may be equipped with wireless networking capabilities, e.g., Wi-Fi connectivity. Wi-Fi is a wireless local area network (WLAN) technology based on the Institute of Electrical & Electronics Engineers (IEEE) 802.11 standards. For example, security system 131 may communicate the video images, still images, and security sensor surveillance information via the triple play service endpoint device 132 along the upstream path to video headend office 111 in the triple play service network 110.

Several video or still cameras can be mounted per zone with each showing a different viewpoint. In case of a burglary, fire emergency, or medical emergency, the cameras are triggered to be turned on and their outputs streamed to the security system 131 inside the subscriber's premise to be transmitted to video headend office 111 via the broadband access network 130 or the wireless access network 120. In one embodiment, security system 131 utilizes prioritized access via triple play service endpoint device 132 as part of the triple play service to send video, pictures, and other security related information. To illustrate, during emergency or security events, such as the detection of a break-in event (e.g., unauthorized opening of a door or a window), detection of a motion event (e.g., motion in a vacant room), detection of a fire event (detection of smoke or elevated temperature), detection of a gas event (detection of the presence of carbon monoxide, natural gas and the like), detection of a loss of heartbeat event (detection of a loss of a heartbeat signal from a sensor that may indicate that the sensor has failed or an intruder has disabled one of the sensors) and the like, the transmission of the video, pictures, and other security related information will have the highest priority, such that the network will interrupt other non-critical IP traffic flows into or out of the customer premise, if necessary. That is, a certain amount of reserved access and core network bandwidth is specifically apportioned for carrying the critical security information via the networks such that the critical security information can be quickly transmitted and evaluated or stored by the proper entity, e.g., a security monitoring service, a subscriber and/or a recording server. For example, a security monitoring service receiving a fire alarm and/or associated video images of a fire inside a subscriber's premise will be able to quickly request emergency services (police, fire fighting service, ambulance service, etc.) to be dispatched to the subscriber's premise.

In one embodiment, the security camera's resolution may be affected by activity in its monitored region. For example, a camera may be turned on or switched to a higher resolution when a motion detector detects activity in the camera's monitored area, turned off or switched to a low resolution image otherwise. This control can be implemented through passage of messages between the various sensing devices (sensors) in the premise network. Thus, an output signal from one sensing device can be used as an input signal to another sensing device. Alternatively these sensing devices could be controlled remotely through commands from the network.

Security system 131 can be optionally outfitted with cellular service capabilities to send video images, still images, and security sensor surveillance information to video headend office 111 using the wireless network 120. This capability ensures that if the land connection is severed, the video images, still images, and security sensor surveillance information can still be transmitted. For example, a burglar may sever a connection to the broadband access network before burglarizing a home, thereby disabling the reporting capability of the security system 131.

Video headend office 111 is responsible for distributing the video images, still images, and security sensor surveillance information received from security system 131 to security monitoring service 140 using flow 144, to security information reception server 142 (for storing the video images, still images, and security sensor surveillance information) using flow 145, and to personal device (e.g., a desktop PC) or mobile device 122 (e.g., a subscriber's mobile device) using flow 146.

Security system 131 may use a secured connection, e.g., via a Virtual Private Network (VPN) connection, to deliver the media stream (video and images) and security sensor information in a prioritized manner to video headend office 111 supported by the triple play service provider. The prioritized access can be achieved, for example, by segmenting a portion of the uplink access bandwidth in broadband access network 130 exclusively for premise monitoring purposes.

Remote monitoring, such as nanny cams and scenarios alike, can be enabled by allowing authorized access to the home surveillance system. For example, the subscriber can be authorized to use mobile device 122 via flow 146 and 141 to access home video images, still images, and security sensor surveillance information from video headend office 111. Configuration of the surveillance system can be provided via the web or through the in-home TV set for added flexibility. Communication channel can be established by the monitoring service or the customer to control various sensing devices at home, e.g., to turn on, to zoom in or out, or swivel one or more cameras.

Multimedia transcoding and recording functionality can be supported by video headend office 111 in the triple play service network. For example, the subscriber may want to view a miniature rendition of his living room captured by a camera on mobile device 122 sent by video headend office 111 using flow 146. Alternatively, security monitoring service 140 may want the highest resolution feed from video headend office 111 using flow 144. Moreover, all the video images, still images, and security sensor surveillance information can also be sent by video headend office 111 to security video information reception server 142 for official record keeping purposes. This allows the service provider of network 110 to provide official validation of time stamps and originating party identification of video images, still images, and security sensor surveillance information related to security events sent by security system 131. This method of storing video images, still images, and security sensor surveillance information storage provides a greater level of legality, integrity and security than allowing the subscriber to store the information locally.

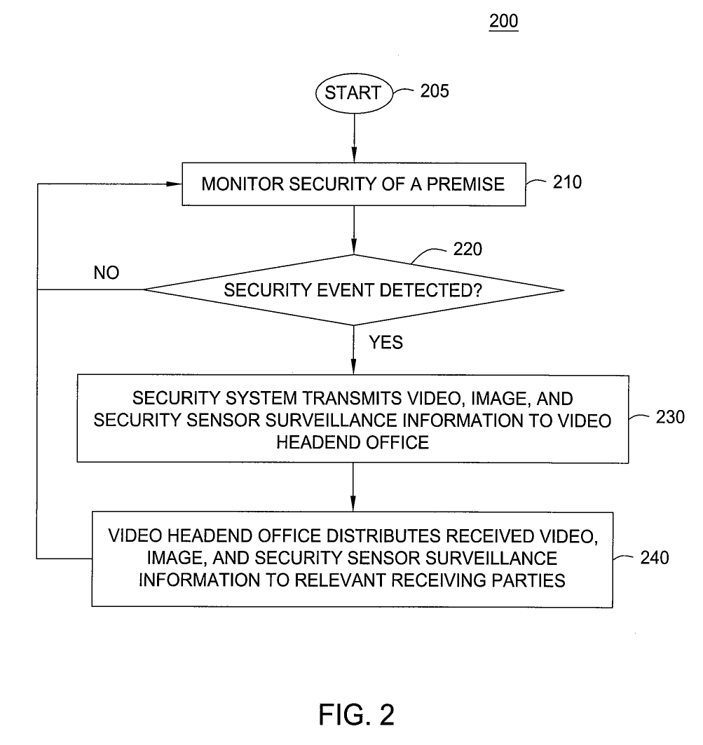

FIG. 2 illustrates an example of premise security monitoring using an IP network, e.g., a triple play service network of the present invention. Method 200 starts in step 205 and proceeds to step 210.

In step 210, the method provides security monitoring of a premise. For example, the monitoring is supported by a security system. The security system is connected to the triple play service network via a triple play service endpoint device. The triple play service endpoint device is, in turn, connected to the triple play service network via a broadband access network or, optionally, a wireless network.

In step 220, the method checks if a security event is detected. If a security event is detected, the method proceeds to step 230; otherwise, the method proceeds back to step 210.

In step 230, the method sends security related information, such as surveillance video images, still image, and/or security sensor data via a broadband access network or a wireless network to the video headend office. The security related information is sent via a prioritized access in said broadband access network to ensure timely delivery of this critical information. Alternatively, the security related information can also be sent via a wireless network.

In step 240, the method distributes the received video images, still images, and/or security sensor surveillance information to relevant receiving parties or entities. The security related information is sent via a prioritized connectivity in the triple play service network to ensure timely delivery of this critical information. In one embodiment, the received security related information can be sent by a video headend office to a security information reception server in the triple play service network for official time stamp and originating party identification validation and record keeping purposes. For example, the storage server will time stamp the received security related information and record the source associated with the security related information (e.g., the identification of a subscriber's premise, e.g., an address of the subscriber's premise, a subscriber's ID code, and the like).

In another embodiment, the received security related information can be sent to a personal device (e.g., a desktop personal computer (PC)) or a mobile device (e.g., a personal digital assistant (PDA) or a cell phone) designated by the subscriber. In one embodiment, video or image data can be transcoded to meet the display capability of the personal device or mobile device, such as a low resolution of the video and image feed. In another embodiment, the received security related information can be sent to a security monitoring service. Video or image data can be transcoded to meet the display capability of the security monitoring service, such as a high resolution of the video and image feed. The method then proceeds back to step 210.

It should be noted that although not specifically specified, one or more steps of method 200 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 2 that recite a determining operation or involve a decision, do not necessarily require that both branches of the determining operation be practiced. In other words, one of the branches of the determining operation can be deemed as an optional step.

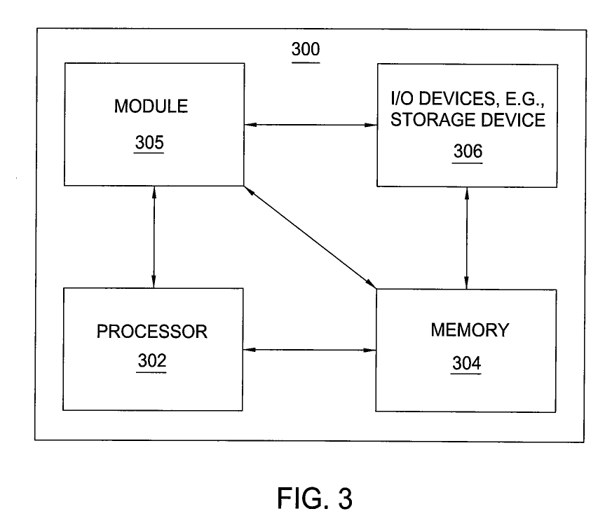

FIG. 3 depicts a high level block diagram of a general purpose computer suitable for use in performing the functions described herein. As depicted in FIG. 3, the system 300 comprises a processor element 302 (e.g., a CPU), a memory 304, e.g., random access memory (RAM) and/or read only memory (ROM), a module 305 for premise monitoring using a triple play service network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 305 for providing premise monitoring using a triple play service network can be loaded into memory 304 and executed by processor 302 to implement the functions as discussed above. As such, the present process 305 for providing premise monitoring using a triple play service network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing premise monitoring via a communication network, comprising:
monitoring a premise via at least one sensing device; and
sending security related information to a headend office in said communication network when a security event is detected, wherein said communication network is a triple play service network supporting a voice service, a video service, and a data service.

2. The method of claim 1, further comprising:
distributing said security related information to one or more designated entities.

3. The method of claim 1, wherein said at least one sensing device is connected to a security system via at least one of: a wired connection or a wireless connection.

4. The method of claim 3, wherein said security system or said at least one sensing device is accessed remotely by a personal device, a mobile device or a security monitoring service.

5. The method of claim 1, wherein said sending comprises:
transmitting said security related information via a broadband access network using a reserved bandwidth; or
transmitting said security related information via a wireless network.

6. The method of claim 1, wherein said security related information comprises at least one of: a plurality of video images, at least one still picture, or sensor data.

7. The method of claim 2, wherein said distributing comprises:
transcoding said received security related information to a different format.

8. The method of claim 2, wherein said one or more designated entities comprise at least one of: a security monitoring service, a personal device, a mobile device, or a storage server.

9. The method of claim 8, wherein said storage server provides at least one of: a time stamp of said security related information or a source of said security related information.

10. A system for providing premise monitoring via a communication network, comprising:
at least one sensing device for monitoring a premise; and
an endpoint device for sending security related information to a headend office in said communication network when a security event is detected,
wherein said communication network is a triple play service network supporting a voice service, a video service, and a data service.

11. The system of claim 10, further comprising:
a headend office for distributing said security related information to one or more designated entities.

12. The system of claim 10, wherein said at least one sensing device is connected to a security system via at least one of: a wired connection or a wireless connection.

13. The system of claim 12, wherein said security system or said at least one sensing device is accessed remotely by a personal device, a mobile device or a security monitoring service.

14. The system of claim 10, wherein said endpoint device transmits said security related information via a broadband access network using a reserved bandwidth, or transmits said security related information via a wireless network.

15. The system of claim 10, wherein said security related information comprises at least one of: a plurality of video images, at least one still picture, or sensor data.

16. The system of claim 11, wherein said headend office transcodes said received security related information to a different format.

17. The system of claim 11, wherein said one or more designated entities comprise at least one of: a security monitoring service, a personal device, a mobile device, or a storage server.

18. The system of claim 17, wherein said storage server provides at least one of: a time stamp of said security related information or a source of said security related information.

19. A computer-readable medium having stored thereon a plurality of instructions, the plurality of instructions including instructions which, when executed by a processor, cause the processor to perform the steps of a method for providing premise monitoring via a communication network, comprising:
monitoring a premise via at least one sensing device; and
sending security related information to a headend office in said communication network when a security event is detected, wherein said communication network is a triple play service network supporting a voice service, a video service, and a data service.

20. The computer-readable medium of claim 19, further comprising:
distributing said security related information to one or more designated entities.
